(19) United States
(12) Patent Application Publication
(10) Pub. No.: US 2009/0225968 A1
(43) Pub. Date: Sep. 10, 2009

(54) DISTRIBUTED CONTACT DATABASE WITH DYNAMIC GROUPING, PRIORITY AND TIME SETTINGS

(76) Inventors: Ameet M. Paranjape, Cedar Park, TX (US); Antonio A. Rosales, Austin, TX (US)

Correspondence Address: LAW OFFICE OF IDO TUCHMAN (AUS), ECM #72212, PO Box 4668, New York, NY, 10163-4668, US

(21) Appl. No.: 12/044,242

(22) Filed: Mar. 7, 2008

(51) Int. Cl. H04M 3/00

(52) U.S. Cl. 379/201.02

(57) ABSTRACT

A system, method and computer program product for managing a plurality of contact options. A first communication device having a first user receives contact options for communicating with a second user. Each contact option specifies a communications modality, addressing information and selection criteria. Selection criteria may include need-to-know groups, times of day and priorities. One of the contact options is automatically selected based on the selection criteria. A communication session is initiated with the second user according to the communications modality and the addressing information specified in the selected contact option.

### FIELD OF THE INVENTION

The present invention relates generally to telecommunications. More specifically, the present invention relates to improved techniques for managing a plurality of contact options for communicating with a user.

### BACKGROUND

Today, many individuals are subscribed to a plurality of communication devices. For example, an individual may have telephones, possibly including a home telephone, a work telephone or a cellular (mobile) telephone. The individual may also have one or more electronic mail (e-mail) accounts. The individual may also be able to send and receive text messages, either via an Internet-based text messaging service or via a cellular telephone. The individual may also have communication devices such as Personal Digital Assistants (PDA's) and pagers. Having a plurality of communication devices advantageously allows people to communicate using a variety of communications modalities from a variety of locations.

An individual may designate different communication devices as having different purposes. For example, the individual may designate an e-mail account for personal e-mail messages only and a PDA for work-related e-mail messages only. Doing so may advantageously increase efficiency and reduce distraction because an individual may ignore a communication device designated for personal communication while in a work environment, and vice versa.

Additionally, an individual may prefer to be contacted via a specific communication device only at specific times of the day and/or on specific days of the week. For example, an individual may prefer not to receive personal calls on a work telephone between 9 AM and 5 PM. Conversely, a technical support representative may be required to accept work-related calls on a cellular telephone between 5 PM and 10 PM but may prefer that communication is directed to an e-mail account after 10 PM.

Many people have dozens or even hundreds of contacts. As noted above, each contact may have multiple communication devices. Thus, the amount of contact information a given person must manage may be substantial.

### SUMMARY OF THE INVENTION

The present invention addresses the above-mentioned limitations of the prior art by introducing improved techniques for managing a plurality of contact options for communicating with a user. An additional level of granularity is added to the contact options for a user in order to optimize the manner in which communication is directed to the user. The level of granularity comprises selection criteria which may include need-to-know groups, times of day and priorities. One of the plurality of contact options can thus be optimally selected based on this added level of granularity.

Thus, one exemplary aspect of the present invention is a method for managing a plurality of contact options. The method comprises receiving at a first communication device having a first user the plurality of contact options from a second communication device having a second user. Each of the plurality of contact options comprises a specification of a communications modality, addressing information and selection criteria for communicating with the second user. The method further comprises automatically selecting, at the first communication device, one of the plurality of contact options based on the selection criteria. The method further comprises initiating, at the first communication device, a communication session with the second user according to the communications modality and the addressing information specified in the selected contact option.

Another exemplary aspect of the present invention is a system for managing a plurality of contact options. The system comprises a first communication device having a first user and a second communication device having a second user. The first communication device is configured to receive the plurality of contact options from a second communication device having a second user. Each of the plurality of contact options comprises a specification of a communications modality, addressing information and selection criteria for communicating with the second user. The first communication device is further configured to automatically select one of the plurality of contact options based on the selection criteria. The first communication device is further configured to initiate a communication session with the second user according to the communications modality and the addressing information specified in the selected contact option.

Another exemplary aspect of the present invention is a computer program product embodied in a tangible media comprising computer readable program codes coupled to the tangible media for managing a plurality of contact options. The computer readable program codes are configured to receive at a first communication device having a first user the plurality of contact options from a second communication device having a second user. Each of the plurality of contact options comprises a specification of a communications modality, addressing information and selection criteria for communicating with the second user. The computer readable program codes are further configured to automatically select, at the first communication device, one of the plurality of contact options based on the selection criteria. The computer readable program codes are further configured to initiate, at the first communication device, a communication session with the second user according to the communications modality and the addressing information specified in the selected contact option.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary system for managing a plurality of contact options embodying the present invention.

FIG. 2 provides additional detail about the communication devices.

FIG. 3 demonstrates an exemplary flowchart of operations for managing a plurality of contact options.

FIG. 4 shows an exemplary flowchart of operations for adding a user at a communication device.

FIG. 5 shows an exemplary flowchart of operations for transmitting updated information about contact options to other users.

### DETAILED DESCRIPTION OF THE INVENTION

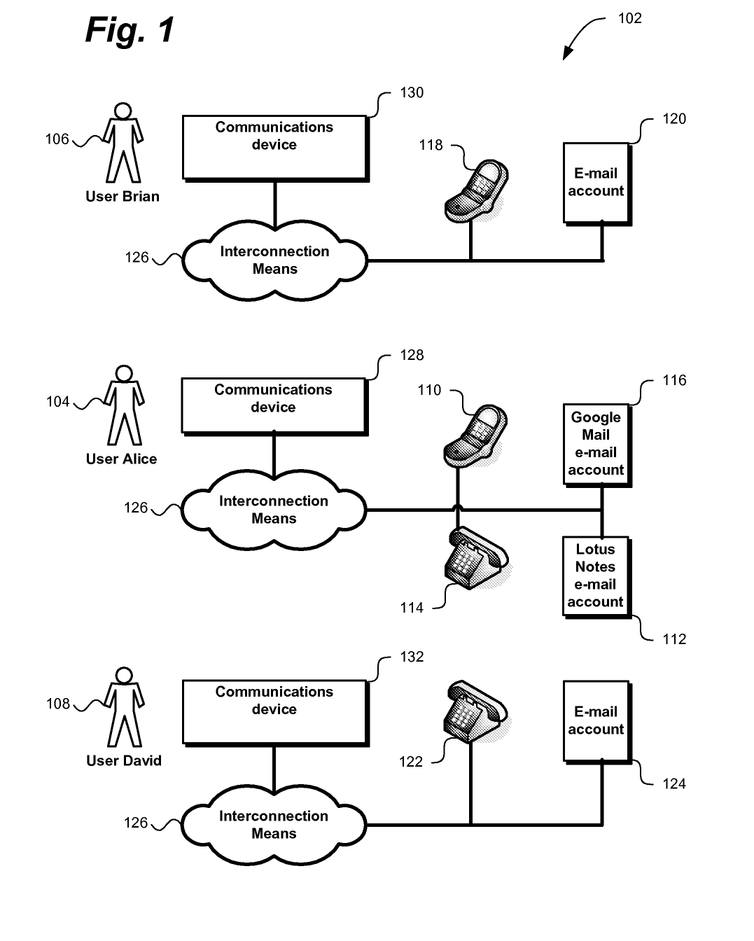

The following description details how the present invention is employed to manage a plurality of contact options. Throughout the description of the invention reference is made to FIGS. 1-5. When referring to the figures, like structures and elements shown throughout are indicated with like reference numerals.

FIG. 1 shows an exemplary system for managing a plurality of contact options embodying the present invention.

The system 102 includes three users, named Alice 104, Brian 106 and David 108. User Alice and user Brian are personal friends. User Alice and user David are work colleagues. Users Alice, Brian and David periodically communicate with each other.

It is emphasized that the present invention is not limited to three users. The number of users depicted in FIG. 1 was selected to facilitate describing the present invention. To the contrary, it is contemplated that the present invention is particularly useful when managing contact information about dozens or even hundreds of users.

Each user 104, 106, 108 in the system 102 has one or more contact options 110, 112, 114, 116, 118, 120, 122, 124. A contact option may be any technological device which is configured to receive communications. Additionally, a contact option may be a postal address. A contact option may be implemented entirely in hardware, entirely in software or in a combination of hardware and software.

Contact options may include telephones. Telephones may include cellular or mobile telephones, such as the iPhone™ mobile digital device. iPhone is a trademark of Apple Inc., Cupertino, Calif., United States. Telephones may also include land line telephones, including home telephones and work telephones.

Contact options may also include electronic mail (e-mail) accounts. The e-mail accounts may be hosted at an enterprise e-mail system operated by an organization, such as the Lotus Notes® software. Lotus Notes is a registered trademark of International Business Machines Corporation, Armonk, N.Y., United States, in the United States, other countries, or both. The e-mail accounts may also be hosted at a web-based e-mail service such as the Google Mail™ webmail service or the Hotmail® web-based e-mail service. Google Mail is a trademark of Google Inc., Mountain View, Calif., United States. Hotmail is a registered trademark of Microsoft Corporation, Redmond, Wash., United States, in the United States and/or other countries. The e-mail accounts may also be hosted at an Internet Service Provider (ISP). An e-mail account may be accessed by clients such as the Thunderbird™ messaging and collaboration client and the Outlook® messaging and collaboration client. Thunderbird is a trademark of the Mozilla Foundation, Mountain View, Calif., United States. Outlook is a registered trademark of Microsoft Corporation, Redmond, Wash., United States, in the United States and/or other countries.

Contact options may also include technological devices configured to send and/or receive text messages. Such devices may include Personal Digital Assistants (PDA's), the Blackberry™ mobile digital device, clients for Internet-based text messaging services and pagers. Blackberry is a trademark of Research In Motion Limited, Waterloo, Ontario, Canada. It is noted that some cellular telephones are configured to send and/or receive text messages.

It is emphasized that the possible types of contact options are not limited to those listed here. Furthermore, the field of communications is one of rapid technological advance. Contact options may include technological devices not known in the art at the time of this application.

A contact option may not be allowable under all circumstances. The context of an interaction may determine which contact options are allowable. Specifically, a contact option may be made available only to users belonging to a defined group, known as a “need-to-know” group. For example, a contact option may be made available only to personal contacts. Similarly, a contact option may be made available only to work contacts.

A contact option may also be allowable only at specific times of the day and/or on specific days of the week. For example, a contact option may be allowable only on Monday through Friday and only during business hours. As another example, a contact option which is a telephone may be allowable only during times of day when the user being contacted is normally awake.

When a plurality of contact options is allowable, one of the contact options may be preferable to the remaining contact option or contact options. For example, a telephone available only during business hours may be preferred to an e-mail account which is available at any time. Thus, during business hours, the telephone should be selected because it is preferred to the e-mail account.

In the exemplary system of FIG. 1, one contact option for user Alice 104 is a cellular telephone 110. The cellular telephone is designated for personal use. User Alice wishes to receive calls at the cellular telephone only between 7 PM and 11 PM on weekdays or at any time of day on weekends. As used herein, weekdays include days between Monday and Friday inclusive, and weekends include Saturday and Sunday. If these constraints are satisfied, the cellular telephone is user Alice's most preferred contact option.

Another contact option for user Alice 104 is an electronic mail account 112 hosted at an installation of the Lotus Notes software. The Lotus Notes e-mail account is designated for work use. User Alice wishes to receive e-mails at the Lotus Notes e-mail account only between 7 AM and 6 PM on weekdays. If these constraints are satisfied, the Lotus Notes e-mail account is user Alice's second most preferred contact option.

Another contact option for user Alice 104 is a work telephone 114 located at her office. The work telephone is a land line telephone which is designated for work use. User Alice wishes to receive calls at the work telephone at any time of day and on any day of the week. If these constraints are satisfied, the work telephone is user Alice's third most preferred option.

Another contact option for user Alice 104 is an e-mail account 116 hosted at the Google Mail webmail service. The Google Mail e-mail account is designated for personal use. User Alice wishes to receive messages at the Google Mail e-mail account at any time of day and on any day of the week. If these constraints are satisfied, the Google Mail e-mail account is user Alice's least preferred option.

User Brian 106 has two contact options. The first is a cellular telephone 118. The second is an e-mail account 120.

User David 108 also has two contact options. The first is a work telephone 122. The second is an e-mail account 124.

Each user 104, 106, 108 in the system 102 has an interconnection means 126. The interconnection means may be any of a wide variety of systems known in the art for allowing two or more systems to communicate. Notably, the interconnection means may connect one or more contact options to the public switched telephone network (PSTN). The interconnection means may comprise any of a wide variety of networks such as the Internet, the PSTN, local area networks (LAN's) and wide area networks (WAN's). The interconnection means may employ any of a wide variety of network technologies such as Wi-Fi®, WiMAX®, Bluetooth®, Ethernet, token ring, Digital Subscriber Line (DSL), cable Internet access, satellite Internet access, Integrated Services Digital Network (ISDN) and dial-up Internet access. Wi-Fi is a registered trademark of the Wi-Fi Alliance, Austin, Tex., United States. WiMAX is a registered trademark of the WiMAX Forum, Mountain View, Calif., United States. Bluetooth is a registered trademark of Bluetooth SIG, Inc., Bellevue, Wash., United States. The interconnection means may include various topologies and protocols known to those skilled in the art, such as TCP/IP, UDP, and Voice over Internet Protocol (VoIP). The interconnection means may comprise direct physical connections, radio waves, microwaves or any combination thereof. Furthermore, the interconnection means may include various networking devices known to those skilled in the art, such as routers, switches, bridges, repeaters, etc.

In an embodiment of the present invention, the interconnection means 126 includes one or more of the IEEE 802.11 series of protocols, including the IEEE 802.11a, IEEE 802.11b and IEEE 802.11g protocols.

In another embodiment of the present invention, the interconnection means 126 includes the Secure Sockets Layer (SSL) protocol. The SSL protocol beneficially encrypts data transmitted thereby.

Each user 104, 106, 108 in the system 102 has a communication device 128, 130, 132 configured to manage contact options.

The communication device may be any of a wide variety of technological devices. A communication device may be implemented in hardware, software or a combination thereof. A communication device may be a stand-alone technological device.

Alternatively, a single technological device may be configured as both a communication device 128, 130, 132 and a contact option. For example, a cellular telephone, an iPhone mobile digital device or a Blackberry mobile digital device could be configured to employ the method of the present invention.

A communication device 128, 130, 132 may also be a software program executing at a general purpose computer. In an embodiment of the present invention, a communication device is a network-based service executing at a general purpose computer. The service may encrypt communications according to the SSL protocol.

A communication device 128, 130, 132 may be local to its user. The term “local” means that the communication device is at the user's node. For example, the communication device could be a cellular telephone, an iPhone mobile digital device or a Blackberry mobile digital device located in proximity to its user.

A communication device may be connected to a wide variety of devices known in the art for transmitting and receiving communications. Such devices may include electronic mail clients, cellular telephones, land line telephones and devices configured to process text messages. In an embodiment of the present invention, these devices are connected to the communication device using the Bluetooth protocol.

Each communication device 128, 130, 132 may store and manage information about contact options for the user to which it belongs. Each communication device may also store and manage information about contact options for other users along with selection criteria for each contact option. Finally, each communication device may also store definitions of need-to-know groups along with the identities of users assigned to each group.

In the exemplary system of FIG. 1, user Alice 104 has a communication device 128. The communication device stores a definition of a need-to-know group named the Personal group. The Personal group includes personal friends of Alice. Thus, the communication device stores the identity of the user Brian as a member of the Personal group. The communication device also stores a definition of a need-to-know group named the Work group. The Work group includes work colleagues of Alice. Thus, the communication device stores the identity of the user David as a member of the Work group.

The communication device 128 for user Alice 104 further stores information about all contact options for communicating with user Alice, including the selection criteria for each contact option. Specifically, the communication device stores information about the cellular telephone, including the selection criteria that it is allowable only to members of the Personal group and only between 7 PM and 11 PM on weekdays and at any hour on weekends and that it has a priority of 1. The communication device also stores information about the Lotus Notes e-mail account, including the selection criteria that it is allowable only to members of the Work group and only between 7 AM and 6 PM on weekdays and that it has a priority of 2. The communication device also stores information about the work telephone, including the selection criteria that it is allowable only to members of the Work group and that it has a priority of 3. The communication device also stores information about the Google Mail e-mail account, including the selection criteria that it is allowable only to members of the Personal group and that it has a priority of 4. In this example, lower numbers for the priority indicate contact options which are more preferred. Additionally, the communication device stores information about the contact options for communicating with users Brian 106 and David 108.

User Brian 106 also has a communication device 130. The communication device stores information about all contact options for communicating with user Brian. The communication device also stores information about the cellular telephone contact option and Google Mail e-mail account contact options for communicating with user Alice. The communication device further stores the selection criteria listed above for both contact options. The Lotus Notes e-mail account and work telephone contact options are not stored at the communication device for user Brian. This is because they are designated for work use and user Brian is a personal friend of user Alice.

User David 108 also has a communication device 132. The communication device stores information about all contact options for communicating with user David. The communication device also stores information about the Lotus Notes e-mail account and work telephone contact options for communicating with user Alice. The communication device further stores the selection criteria listed above for both contact options. The cellular telephone and Google Mail e-mail account contact options are not stored at the communication device for user David. This is because they are designated for personal use and user David is a work colleague of user Alice.

Assume user Brian 106 wishes to communicate with user Alice 104. User Brian may direct his communication device 130 to initiate a communication session with user Alice. In response to this directive, the communication device automatically selects one of the contact options for communicating with user Alice based on the selection criteria. For example, if it is 5 PM on a Sunday, the cellular telephone will be selected because it is allowable at that time and it has the best priority. Conversely, if it is 2 PM on a Wednesday, the Google Mail e-mail account will be selected because it is the only contact option allowable at that time for members of the Personal group. The communication device then initiates a communication session with Alice via the selected contact option.

Assume user David 108 also wishes to contact user Alice 104. User David may direct his communication device 132 to initiate a communication session with user Alice. In response to this directive, the communication device automatically selects one of the contact options for communicating with user Alice based on the selection criteria. For example, if it is 9 AM on a Tuesday, the work telephone will be selected because it is allowable at that time and it has the best priority of the allowable contact options. Conversely, if it is 8 PM on a Thursday, the Lotus Notes e-mail account will be selected because it is the only contact option allowable at that time for members of the Work group. The communication device then initiates a communication session with Alice via the selected contact option.

It is emphasized that in these examples, the communication devices 130, 132 of the users Brian 106 and David 108 actively enforce the preferences of the user Alice 104. This advantageously prevents accidentally or intentionally directing communication to a contact option on which user Alice does not wish to receive communication given the context. Moreover, specifying permissible times of day may beneficially redirect communication away from contact options which are likely to be unattended.

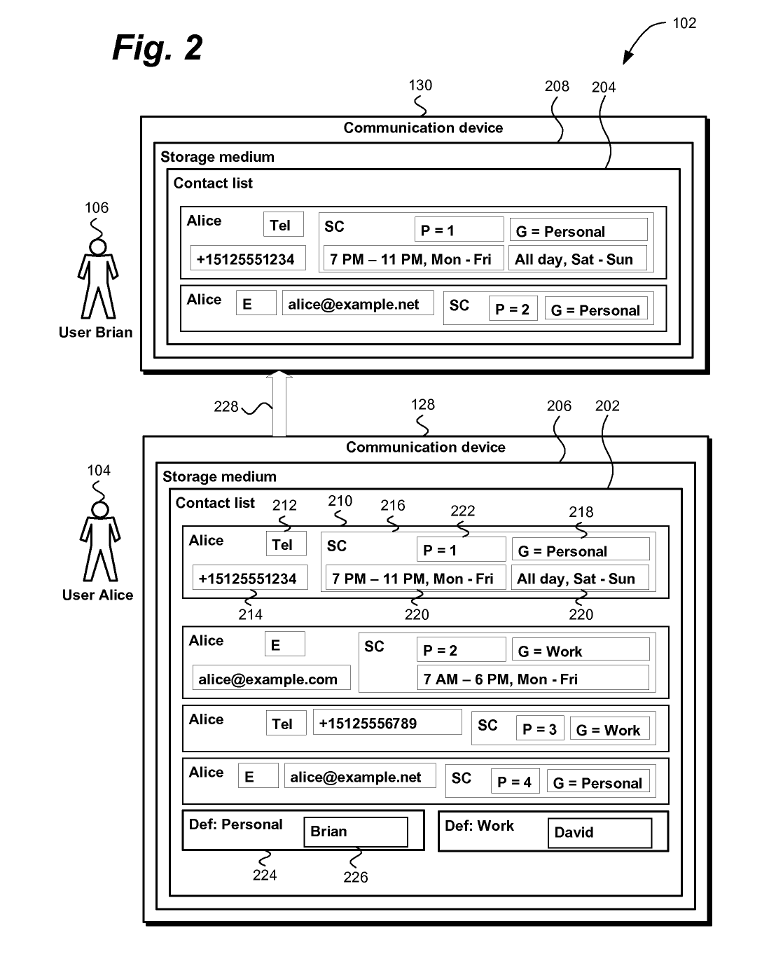

Turning now to FIG. 2, additional detail is provided about the communication devices. The system 102 includes a first communication device 128 having a first user 104. The system further includes a second communication device 130 having a second user 106. In the exemplary system of FIG. 2, the first communication device 128 has a user Alice 104. The second communication device 130 has a user Brian 106.

In an embodiment of the present invention, the first communication device 128 and the second communication device 130 may communicate according to one or more of the IEEE 802.11 series of protocols, including the IEEE 802.11a, IEEE 802.11b and IEEE 802.11g protocols.

In another embodiment of the present invention, the first communication device 128 and the second communication device 130 may communicate according to the Secure Sockets Layer (SSL) protocol. The SSL protocol beneficially encrypts data transmitted thereby. Additionally, the SSL protocol advantageously provides authentication with handshaking. The first user 104 may have a certificate, signature or public-private key pair to confirm its authenticity to the second user 106.

The communication devices, including the first communication device 128 and the second communication device 130, must be able to communicate via interconnecting networks. Moreover, the communication devices must execute a common protocol for communicating with each other. The protocol may be any of various telephony and paging protcols known to those skilled in the art.

Each communication device 128, 130 may store contact options at a contact list 202, 204. A contact list may be stored at a database. A contact option and the data elements included therein may be expressed using any of a variety of data structures known in the art. It is noted that as used herein, the term “contact option” may refer to information about a contact option.

In an embodiment of the present invention, each communication device includes means for data storage 206, 208. The contact list is thus stored at the included data storage means.

In another embodiment of the present invention, the contact list may be stored at a location other than the communication device. For example, the contact list may be stored at a laptop computer. As another example, the contact list may be stored at a technological device configured to process contact information. Such a technological device may be external to, but local to, the communication device. Such technological devices may include the iPhone mobile digital device and the Blackberry mobile digital device. Such technological devices may also include software configured to manage a contact list, such as the Thunderbird messaging and collaboration client and the Outlook messaging and collaboration client.

Each of the plurality of contact options 210 stored at a communication device 128, 130 comprises a specification of a communications modality 212. A “communications modality” is any type of electronic communication known in the art. Communication modalities may include without limitation electronic mail (e-mail), telephony, FAX, text messaging and postal mail.

Each of the plurality of contact options 210 stored at a communication device 128, 130 further comprises addressing information 214. “Addressing information” is any information by which a user of a communication service may be contacted. If the communications modality is e-mail, the addressing information may be an e-mail address. If the communications modality is telephony or FAX, the addressing information may be a telephone number. The telephone number may or may not include codes indicating geographic locations such as country codes, area codes and city codes. The telephone number may or may not include an extension. The telephone number may denote a land line telephone, a cellular or mobile telephone, a FAX machine or any other technological device connected to the public switched telephone network (PSTN.) If the communications modality is text messaging, the addressing information may be a username or nickname within a text messaging service. If the communications modality is postal mail, the addressing information may be a postal address.

A communication modality may be specified implicitly rather than explicitly. In particular, it may be possible to infer the communications modality from some types of addressing information. For example, the addressing information may be a Uniform Resource Locator (URL.) Because URL's specify both a protocol and addressing information, the communications modality may be inferred from the URL. Furthermore, in an embodiment of the present invention which is configured to process only one communications modality, the communications modality may be inferred to be the only one the embodiment is configured to process.

Each of the plurality of contact options stored at a communication device 128, 130 further comprises selection criteria 216. “Selection criteria” are rules which specify conditions which must hold in order to communicate with a user using the contact option associated with the selection criteria.

Selection criteria 216 may comprise at least one need-to-know group 218 which is associated with the contact option 210. A need-to-know group comprises one or more users 104, 106. The definitions of the users included in the need-to-know groups need not be stored in a data structure containing the data for the contact option 210. This type of selection criterion specifies that the contact option should not be allowable to a user who is not included in any of the need-to-know groups included in the selection criteria.

Selection criteria 216 may further comprise at least one time range 220 for communicating with a user 104, 106 using the contact option 210 associated with the selection criteria. Each time range may comprise at least one day of a week. A time range may specify one or more days of a week but may match any time on the specified days. This type of selection criterion specifies that the contact option should not be allowable if the time range for communicating with the user is not satisfied.

Selection criteria 216 may further comprise a priority 222. The priority determines which contact option 210 is selected when two or more contact options are not excluded after the selection criteria have been applied. The value of the priority may be numeric.

In an embodiment of the present invention, the values of the priorities 222 are unique across all contact options 210 for the same user 104, 106. This beneficially ensures that even if a user is included in more than one need-to-know group, the values of the priorities are unique across all contact options allowable to that user.

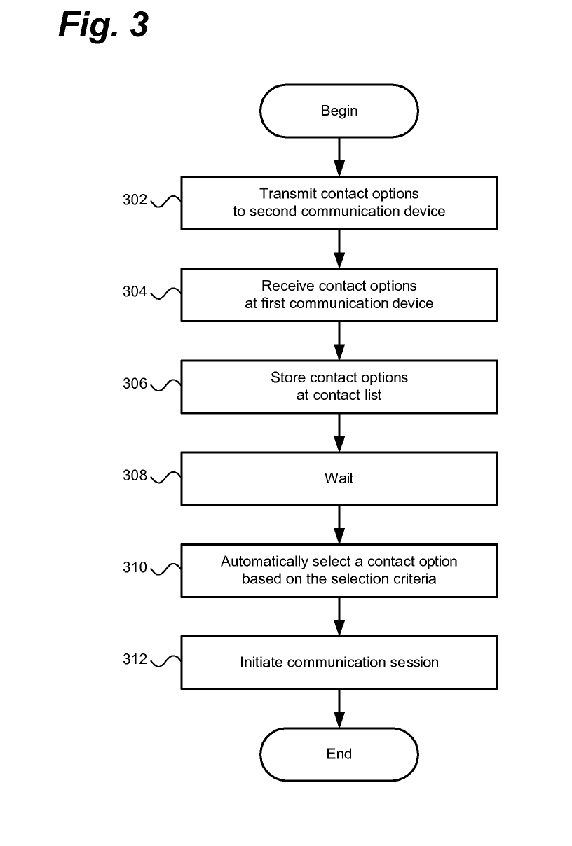

In another embodiment of the present invention, multiple contact options 210 for the same user 104, 106 may have identical values for the priority 222. For example, two contact options could have a priority value of 1. Thus, multiple contact options having the same priority may remain once all other selection criteria 216 have been applied. The description of selecting operation 308 of FIG. 3 discusses how this condition may be resolved.

In an embodiment of the present invention, lower numeric values for the priority 222 indicate contact options 210 having a higher importance. Furthermore, the priorities for all contact options for communicating with a specific user 104, 106 are assigned as consecutive integers beginning with 1. These rules apply to the exemplary system shown in FIG. 2.

The values of the priorities need not be assigned as described in any of the embodiments outlined above. For example, higher numeric values for the priority may indicate contact options having a higher importance.

It is emphasized that selection criteria 216 are not limited to the specific types of selection criteria described above. Those skilled in the art can adapt the present invention to implement a wide variety of rules as selection criteria.

Thus, in the exemplary system of FIG. 2, the communication device 128 for user Alice 104 stores information about all contact options 210 for communicating with user Alice 104. It is noted that user Alice has the same contact options as shown in FIG. 1. Thus, the communication device stores as a contact option information about the cellular telephone. The contact option comprises a specification 212 that the communications modality is telephony. The contact option further comprises addressing information 214 consisting of the telephone number of the cellular telephone. The contact option further comprises selection criteria 216. The selection criteria include an indication 218 that the Personal need-to-know group is associated with the contact option. The selection criteria further include two time ranges 220. The first time range is between 7 PM and 11 PM on a weekday. The second time range is the entire day on a weekend. The selection criteria further include a priority 222 of 1.

The communication device 128 also stores as a contact option information about the Lotus Notes e-mail account. The contact option comprises a specification that the communications modality is e-mail. The contact option further comprises addressing information consisting of the e-mail address associated with the e-mail account. The contact option further comprises selection criteria. The selection criteria include an indication that the Work need-to-know group is associated with the contact option. The selection criteria further include a time range of 7 AM to 6 PM on weekdays. The selection criteria further include a priority of 2.

The communication device 128 also stores as a contact option information about the work telephone. The contact option comprises a specification that the communications modality is telephony. The contact option further comprises addressing information consisting of the telephone number of the work telephone. The contact option further comprises selection criteria. The selection criteria include an indication that the Work need-to-know group is associated with the contact option. The selection criteria further include a priority of 3.

The communication device 128 also stores as a contact option information about the Google Mail e-mail account. The contact option comprises a specification that the communications modality is e-mail. The contact option further comprises addressing information consisting of the e-mail address associated with the e-mail account. The contact option further comprises selection criteria. The selection criteria include an indication that the Personal need-to-know group is associated with the contact option. The selection criteria further include a priority of 4.

The communication devices 128, 130 also maintain definitions 224 of need-to-know groups. The definitions of the need-to-know groups stored at a communication device for a user may apply to all contact options for communicating with that user. Each need-to-know group comprises one or more users. An indication 226 of the identity of each user included in the need-to-know group is stored along with the definition of the group. Definitions of need-to-know groups may or may not be stored at a contact list 202, 204. Definitions of need-to-know groups may be stored at a means for data storage 206, 208 included in the communication device. The definitions may also be stored at a technological device configured to process contact information and external to the communication device. Such technological devices may include any of the specific possibilities listed above in regards to the contact list.

In the exemplary system of FIG. 2, the communication device 128 for user Alice 104 stores a definition of a need-to-know group named the Personal group 224. The Personal group includes personal friends of Alice. Thus, the communication device stores the identity 226 of the user Brian 106 as a member of the Personal group.

The communication device 128 for user Alice 104 also stores a definition of a need-to-know group named the Work group. The Work group includes work colleagues of Alice. Thus, the communication device stores the identity of the user David as a member of the Work group.

It is noted that the need-to-know groups need not be limited to a Personal group and a Work group. Moreover, the number of need-to-know groups need not be limited to two and may in fact be very large. For example, a third need-to-know group called the School group could be defined. The selection criteria could be configured so that users included in the School group may communicate via both contact options allowable to the Personal group and contact options allowable to the Work group.

Furthermore, the same user may be included in two or more need-to-know groups. For example, the same user could be included in both the Personal group and the Work group shown in FIG. 2.

A communication device 128 for a first user 104 may transmit 228 to the communication device 130 of a second user 106 contact options 210 for communicating with the first user. The transmitted contact options may comprise the attributes and data described above. When transmitting the contact options, the communication device for the first user may omit any contact option for which the second user is not included in any need-to-know group included in the selection criteria 216 for the contact option. Furthermore, the priorities 222 included in the transmitted contact options may be renumbered as consecutive integers starting with 1. In performing the renumbering operation, the previous ordering of the priorities is preserved.

In the exemplary system of FIG. 2, the communication device 128 for user Alice 104 transmits 228 to the communication device 130 for user Brian 106 contact options 210 for communicating with user Alice. User Brian is included in the Personal need-to-know group but is not included in the Work need-to-know group. Therefore, only the contact option for the cellular telephone and the contact option for the Google Mail e-mail account are transmitted. Both contact options are associated with the Personal need-to-know group in which user Brian is included. The contact option for the Lotus Notes e-mail account and the contact option for the work telephone are not transmitted. Both contact options are associated with the Work need-to-know group in which user Brian is not included. Furthermore, the priority of the Google Mail e-mail account is renumbered from 4 to 2 so that the priorities are consecutive integers.

The communication device 130 for the second user 106 receives the transmitted contact options 210 for communicating with the first user 104. The received contact options may comprise the attributes and data described above. The communication device for the second user may then store the received contact options. The received contact options may be stored at a contact list 204.

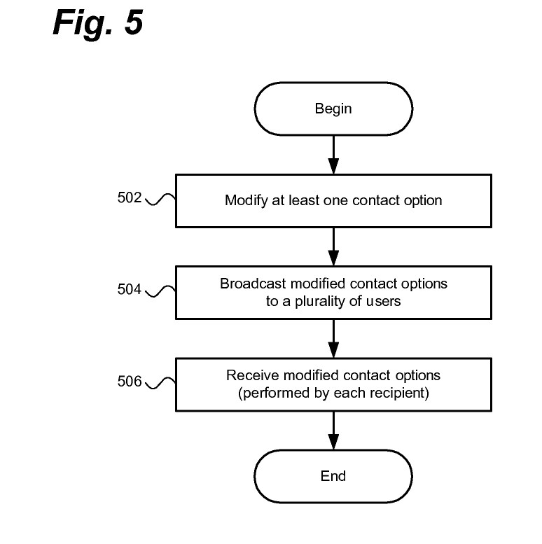

In an embodiment of the present invention, the transmitting and receiving of the contact options is repeated at regular intervals. Transmitting the contact options may be achieved according to the exemplary algorithm described in FIG. 5.

In another embodiment of the present invention, transmitting and receiving of the contact options is performed in response to a request by the first user to contact the second user. The communication device for the first user compares its contact options for communicating with the second user with the contact options for communicating with the second user stored at the communication device for the second user. If the contact options at the communication device for the first user and the contact options stored at the communication device for the second user are in synchronization, no update is necessary. Otherwise, the contact options are transmitted, received and possibly stored as described above. Communication with the second user then occurs according to the updated contact options as described below.

In the exemplary system of FIG. 2, the communication device 130 for user Brian 106 receives the transmitted contact options for communicating with user Alice 104. The received contact options are stored at the contact list 204. Thus, the communication device for user Brian stores as a contact option 210 information about the cellular telephone. The contact option comprises a communications modality 212, addressing information 214 and selection criteria 216 containing the same values described above. The communication device for user Brian also stores as a contact option information about the Google Mail e-mail account. The contact option comprises a communications modality, addressing information and selection criteria containing the same values described above, except that the priority is changed to 2 as previously noted.

It is noted that the different information stored at the communication device 128 for user Alice 104 and the communication device 130 for user Brian 106 can be considered as two different views of the contact options for communicating with user Alice. The owner view, as represented by the information stored at the communication device for user Alice, includes the complete list of contact options 210. The client view, as represented by the information stored at the communication device for user Brian, includes only contact options to which the user Brian has access.

The communication device 130 for the second user 106 then automatically selects one of the contact options 210 based on the selection criteria 216. The communication device may exclude any contact option whose time range 220 for communicating with the second user is not satisfied. Any other selection criteria may also be applied.

After applying the selection criteria 216, multiple contact options 210 may remain which were not excluded by the selection criteria. When this is the case, the communication device 130 for the second user 106 may select, from a set including each of the contact options not excluded based on the selection criteria, a contact option having a priority 222 which indicates an importance at least as great as is indicated by any other priority included within the set.

In the exemplary system of FIG. 2, at 2 PM on a Wednesday, the cellular telephone will be excluded by the selection criteria 216. This is because neither of the time ranges 220 included in the selection criteria are satisfied by a time of 2 PM on a Wednesday. Because the Google Mail e-mail account is the only contact option not excluded by the selection criteria, it is selected.

If it is instead 5 PM on a Sunday, in the selection criteria 216 for the cellular telephone, the time range 220 specifying the entire day on a weekend is satisfied. Therefore, the cellular telephone is not excluded based on the selection criteria. The Google Mail e-mail account is also not excluded because its selection criteria do not include any time range. As a result, two contact options 210 remain which are not excluded. In response to this condition, the communication device 130 for user Brian 106 analyzes the priorities 222 included in the selection criteria for both contact options. The priority of the cellular telephone is 1, while the priority of the Google Mail e-mail account is 2. Therefore, the communication device selects the cellular telephone.

The communication device 130 for the second user 106 then initiates a communication session with the first user 104 according to the communications modality 212 and the addressing information 214 specified in the selected contact option 210.

It is noted that if a communication device 128 for a first user 104 stores contact options for communicating with a second user 106, the communication device 130 for the second user may also store contact options for communicating with the first user. For example, the communication device for user Alice may additionally store contact options for communicating with user Brian. However, the present invention does not require this condition to hold.

Turning now to FIG. 3, an exemplary flowchart of operations for managing a plurality of contact options is demonstrated. The operations listed include those performed by both a first communication device and a second communication device. The first communication device has a first user. The second communication device has a second user. The first communication device and the second communication device have the properties discussed above in regards to FIGS. 1 and 2. The flowchart is generally arranged in temporal sequence, rather than according to which communication device is performing each operation.

At transmitting operation 302, contact options for communicating with the second user are transmitted from the second communication device to the first communication device. The contact options may be transmitted using any of a variety of network protocols and techniques known in the art. The transmitted data may be expressed in any of a variety of data formats.

Each contact option comprises a specification of a communications modality and addressing information. The communications modality and addressing information have the properties discussed in the description of FIG. 2.

Each contact option further comprises selection criteria. The selection criteria have the properties shown in FIG. 2 and discussed in the description thereof. In particular, the selection criteria may include at least one need-to-know group associated with the contact option. Each need-to-know group comprises one or more users. The selection criteria may further comprise at least one time range for communicating with the second user using the contact option associated with the selection criteria. A time range may comprise at least one day of a week. The selection criteria may further comprise a priority.

If the selection criteria for a contact option include at least one need-to-know group, it is possible that the first user is not included in any of the need-to-know groups. In this case, the contact option is never allowable to the first user unless the selection criteria or the list of users included in the need-to-know groups are changed. Thus, in an embodiment of the present invention, when transmitting the contact options, any contact option for which the first user is not included in any need-to-know group included in the selection criteria is omitted. Omitting such contact options beneficially prevents the first user from receiving addressing information for contact options which the first user is not authorized to use. This, in turn, reduces network bandwidth requirements. Furthermore, processing time requirements are advantageously reduced because the communication device for the first user need not process the omitted contact options.

If the selection criteria for a contact option do not include a need-to-know group, the contact option may be considered allowable for any user. In this case, the contact option may never be omitted as described above.

In another embodiment of the present invention, all contact options for communicating with the second user are transmitted to the first user.

Transmitting operation 302 may include renumbering the priorities included in the transmitted contact options to be consecutive integers starting with 1. In performing the renumbering operation, the previous ordering of the priorities is preserved.

It is noted that transmitting operation 302 and receiving operation 304 may overlap in time. In particular, receiving operation 304 may receive earlier data in the transmitted data sequence concurrently with transmitting operation 302 transmitting later data in the transmitted data sequence. Nonetheless, receiving operation 304 cannot begin before transmitting operation 302 begins because the earliest data in the transmitted data sequence cannot be received until it has been transmitted. Similarly, receiving operation 304 cannot terminate before transmitting operation 302 terminates because the latest data in the transmitted data sequence cannot be received until it has been transmitted.

At receiving operation 304, the contact options transmitted from the second communication device are received at the first communication device. The received contact options have the properties previously discussed. In particular, each of the received contact options comprises a specification of a communications modality, addressing information and selection criteria for communicating with the second user. After receiving operation 304 is completed, control passes to storing operation 306.

At storing operation 306, the received contact options are stored at a contact list. Storing operation 306 may be performed by the first communication device. Details of an exemplary contact list are provided in the description of FIG. 2. After storing operation 306 is completed, control passes to waiting operation 308.

At waiting operation 308, the first communication device waits for an event. The event may be a request to communicate with the second user. The request may comprise user input. The user input may be received at any of a variety of user interface devices known in the art, including without limitation keyboards, keypads, mice, voice user interfaces and touch screens. In an embodiment of the present invention, the request comprises a user pressing a button. When the event is detected, control passes to selecting operation 310.

At selecting operation 310, the first communication device automatically selects one of the contact options based on the selection criteria.

Selecting operation 310 may initially populate a set with all of the contact options for communicating with the second user received at receiving operation 304. It is noted that any contact option omitted at transmitting operation 302 due to not fulfilling a selection criterion specifying one or more need-to-know groups will be absent from the set and therefore will not be selected.

As previously noted, selection criteria are rules which specify conditions which must hold in order to communicate with a user using the contact option associated with the selection criteria. Thus, broadly speaking, selecting operation 310 comprises excluding any contact option which fails to fulfill any rule specified by a selection criterion. Any contact option thus excluded may therefore be removed from the set.

As previously noted, the selection criteria for a contact option may comprise at least one time range. Such a time range may further specify at least one day of a week. Selecting operation 310 may comprise excluding any contact option for which none of the at least one time ranges for communicating with the second user are satisfied. If a time range specifies one or more days of the week but does not specify a start time and an end time, the time range may be considered satisfied if the current date is one of the specified days of the week. If a time range specifies a start time, an end time and one or more days of the week, the time range may be considered satisfied if the current time is at or after the start time, the current time is at or before the end time and the current date is one of the specified days of the week. If a time range does not specify one or more days of the week, the time range may be considered satisfied if the current time is at or after the start time and is at or before the end time. The current date and time may be the date and time at which contact is initiated.

In some cases, the first user and the second user will not be located in the same time zone. In an embodiment of the present invention, the first communication device translates between the time zones in which the two users are located. Translation may include converting the current date and time to the time zone of the second user and inputting the converted date and time to the comparisons listed above. Alternatively, any time ranges included in the received contact options may be converted to the time zone of the first user. In another embodiment of the present invention, transmitting operation 302 includes translating any time ranges included in the transmitted contact options to the time zone of the first user. It is noted that algorithms for converting date and time information expressed in one time zone to another time zone are known in the art.

If the selection criteria for a contact option do not include a time range, the contact option may be considered allowable at any date and time.

If contact options for which the first user is not included in any need-to-know group included in the selection criteria were not omitted at transmitting operation 302, selection operation 310 must enforce this selection criterion where it is present. Specifically, in this case, selecting operation 310 may comprise excluding any contact option for which the first user is not included in any need-to-know group included in the selection criteria.

As previously noted, the selection criteria for a contact option may comprise a priority. Selecting operation 310 may comprise selecting, from the set including each of the plurality of contact options not excluded based on the selection criteria, a contact option having a priority which indicates an importance at least as great as is indicated by any other priority included within the set when the set includes two or more contact options. Thus, when two or more contact options remain after applying the selection criteria, the priority may determine which of the remaining contact options is selected.

Conversely, when the set includes only one contact option, that contact option will be selected. In this case, the first communication device may ignore the priority because it has no effect on which contact option is selected.

If lower numeric values for the priority indicate contact options having a higher importance, the contact option in the set having the lowest priority may be selected. If instead higher numeric values for the priority indicate contact options having a higher importance, the contact option in the set having the highest priority may be selected.

If two contact options can have the same priority, multiple contact options having identical values for the priority may remain at this point. By definition, this condition indicates that the contact options having identical priorities are of equal importance. Therefore, it is contemplated that if multiple contact options have identical values for the priority, and the identical values indicate greater importance than any other contact option which was not excluded after the selection criteria have been applied, it is unimportant which of the contact options is selected. Thus, in this case, the first user may be prompted to select one contact option from the plurality of contact options having identical values for the priority. Alternatively, one of the contact options may be selected using a trivial algorithm, e.g., by selecting the first of the contact options.

Selecting operation 310 may include displaying the priority and type of the selected contact option. Selecting operation 310 may also include displaying information about all contact options which are available to the first user at the present moment in time.

It is emphasized that selecting operation 310 causes the first communication device to actively enforce the preferences of the second user as to which contact option is selected given the context of the interaction.

In an embodiment of the present invention, the first user may override the priorities of the contact options. In this case, all contact options not excluded based on the selection criteria are displayed or otherwise communicated to the first user. For example, all contact options for which the first user is in the appropriate need-to-know group and which are allowable at the current time may be displayed. The priority of each of the contact options is also displayed to the first user. The first user then manually selects one of the displayed contact options. It is noted that when only one contact option is not excluded based on the selection criteria, the first user may not be provided the opportunity to override the priorities, as that contact option is the only one available to the first user.

After selecting operation 310 is completed, control passes to initiating operation 312.

At initiating operation 312, the first communication device initiates a communication session with the second user according to the communications modality and the addressing information specified in the selected contact option. The first communication device may itself initiate the communication session. The first communication device may instead direct another technological device to initiate the communication session. For example, if the first communication device is a computer and the communications modality is telephony, the first communication device may direct the telephone indicated by the addressing information to initiate a telephone call. The first communication device may also prompt the first user to communicate according to the communications modality and the addressing information.

The exact action taken at initiating operation 312 depends on the communications modality specified in the selected contact option. For example, if the communications modality is e-mail, an e-mail message may be transmitted. The e-mail address to which the e-mail message is transmitted may be based on the addressing information in the selected contact option. Before transmitting the message, a user interface may be provided for the first user to specify the content of the e-mail message. If the communication device is configured to provide a graphical user interface (GUI), providing a user interface may include instantiating a window in which the first user may input the content. However, some communication devices, such as telephones, are primarily configured to process voice input. Such devices may instead receive the content for the e-mail message as voice input. The received voice input may, for example, be attached to the e-mail message as a file in MP3 format.

If the communications modality is telephony, a telephone call may be initiated. The telephone number dialed to initiate the call may be based on the addressing information in the selected contact option. If the communication device is not configured to process voice input, the communication device may instead allow the user to enter a message as text, e.g., by using a keyboard. The communication device may then employ text-to-speech conversion to convert the text message to audio form for transmission via telephone.

If the communications modality is text messaging, a text messaging session may be initiated. The session may include both the first user and another user whose username is based on the addressing information in the selected contact option.

If the communications modality is postal mail, a prompt may be displayed to the first user. The prompt may include a postal address included in the addressing information. If the postal address is the only allowable contact option by which the first user may contact the second user, the prompt may include a message specifying that the only acceptable contact option is to send postal mail.

In an embodiment of the present invention, selecting operation 310 is not performed by the first communication device. Initiating operation 312 transmits communication to the second communication device. The second communication device then performs selecting operation 310 as described above. The second communication device may then redirect the communication to the selected contact option. It is noted that in this embodiment, transmitting operation 302 and receiving operation 304 may also be omitted.

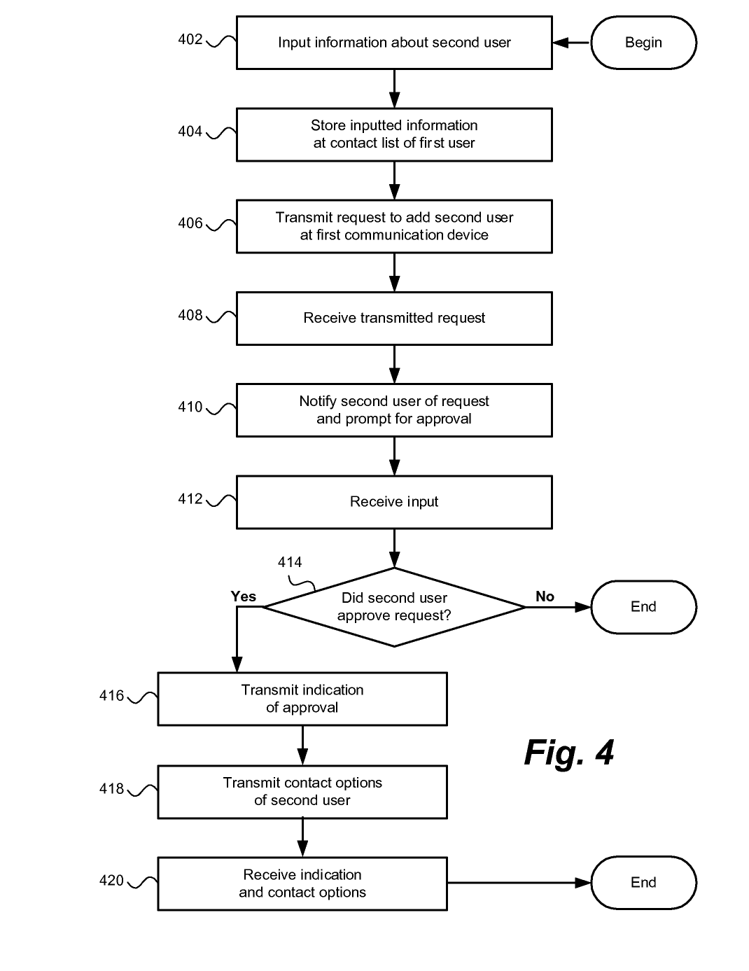

FIG. 4 shows an exemplary flowchart of operations for adding a user at a communication device. The operations listed include those performed by a first communication device, a first user, a second communication device and a second user. The first communication device and the second communication device have the properties discussed above in regards to FIGS. 1 and 2. The flowchart is generally arranged in temporal sequence, rather than according to which user or communication device is performing each operation. The operations shown in FIG. 4 may constitute a handshake and agreement process.

At inputting operation 402, the first user inputs information about the second user. The information may include contact information for the second user. Contact information may include without limitation e-mail addresses, telephone numbers and FAX numbers. The information may further include a specification of one or more need-to-know groups to which the second user should be added.

The inputting operation may comprise manual data entry. The inputting operation may also comprise importing data from an external application or database. Contact information may also be retrieved from a communication transmitted by the second user. For example, the e-mail address and/or the name of the sender of an e-mail message transmitted by the second user may be retrieved from the e-mail message. Caller ID information associated with a telephone call originated by the second user may also be retrieved.

To continue the example from FIGS. 1 and 2, assume that user Alice is the first user and user Brian is the second user. However, assume that neither user has yet added the other user to a contact list. Suppose that user Alice inputs information about user Brian to the communication device for user Alice. User Alice further adds user Brian to the Personal need-to-know group.

After inputting operation 402 is completed, control passes to storing operation 404.

At storing operation 404, the information entered at inputting operation 402 is stored at the contact list for the first user. Thus, the second user is added to the contact list of the first user.

Adding the second user to the contact list of the first user may cause the second user to receive updated contact options for communicating with the first user according to the present invention. Thus, the sequence of operations in FIG. 4 may cause two users to each receive updates to the contact options for communicating with the other user according to the present invention. However, the present invention does not require adding users as disclosed herein to be bilateral in nature. Instead, a first user to receive contact options for a second user but not vice versa.

To continue the previous example, storing operation 404 may cause the contact information for user Brian to be stored at a contact list. As a result, user Brian will be subscribed to receive contact options for user Alice, including the cellular telephone and the Google Mail e-mail account.

It is noted that at this point, contact information for the second user is stored at the contact list for the first user. However, this contact information may be incomplete, outdated or simply incorrect. Furthermore, in the present state, the contact information will not be automatically updated in the event of changes thereto. Therefore, it would be advantageous to receive updates to the contact information, both at this point in time and upon any future changes to the contact information.

After storing operation 404 is completed, control passes to transmitting operation 406.

At transmitting operation 406, a request is transmitted to add the second user at the first communication device. The request is transmitted from the first communication device to the second communication device. The contact information input at inputting operation 402 may be employed to locate the second communication device.

At receiving operation 408, the second communication device receives the request transmitted at transmitting operation 406. After receiving operation 408 is completed, control passes to notifying operation 410.

At notifying operation 410, the second communication device transmits a notification to the second user. The notification may include any of a variety of user interface devices known in the art. For example, the notification may include displaying a dialog box. The notification may include a message stating that the first user added the second user to the contact list of the first user. The notification further includes a prompt to ask the second user whether to share contact options, including selection criteria such as priorities and approved time ranges, with the first user. The notification may further provide an input field to allow the second user to specify one or more need-to-know groups to which the first user should be added. Notifying operation 410 may then wait until the second user responds to the prompt. After notifying operation 410 is completed, control passes to receiving operation 412.

At receiving operation 412, the input for which the second user was prompted is received. If an input field for specifying one or more need-to-know groups was provided, the first user may be added to the specified need-to-know group or groups. After receiving operation 412 is completed, control passes to determining operation 414.

At determining operation 414, it is determined whether or not the second user specified that contact options for the second user should be shared with the first user. If the second user specified that contact options should be shared, control passes to transmitting operation 416.

If instead the second user specified that contact options should not be shared, the second communication device transmits an indication to the first communication device. The indication specifies that approval was not granted by the second user to add the second user at the first communication device. The indication is received at the first communication device. In this case, the contact information for the second user input at inputting operation 402 may remain stored at the contact list for the first user. Moreover, updates to the contact options for communicating with the second user will not occur at the contact list for the first user.

At transmitting operation 416, the second communication device transmits an indication to the first communication device. The indication specifies that approval is received from the second user to add the second user at the first communication device.

At transmitting operation 418, the second communication device transmits, to the first communication device, contact options for communicating with the second user. Transmitting operation 418 may comprise the method steps included in transmitting operation 302 of FIG. 3.

At receiving operation 420, the indication transmitted at transmitting operation 416 and the contact options transmitted at transmitting operation 418 are received at the first communication device. In order to receive the contact options, receiving operation 420 may further comprise the method steps included in receiving operation 304 and storing operation 306 of FIG. 3. It is contemplated that as a result, the information about the second user at the contact list is updated to include the complete and current contact options.

In an embodiment of the present invention, contact information entered at inputting operation 402 may be replaced or deleted from the contact list when updated contact options are received. For example, suppose user Alice entered the telephone number of a work telephone for user Brian at inputting operation 402. At notifying operation 410, user Brian may specify that user Alice is to be included only in the Personal need-to-know group. In this case, only the contact options approved for the Personal need-to-know group are transmitted to user Alice. Thus, the telephone number for the work telephone is deleted from the contact list for user Alice.

After receiving operation 420 is completed, adding the second user at the first communication device is complete. Beginning at this point in time, the contact options for communicating with the second user should be updated at the contact list for the first user when they are updated at the contact list for the second user. Further details about this process are shown in FIG. 5.

A first user may also elect to be removed from the contact list of a second user. In an embodiment of the present invention, the second user may transmit to the first user the lowest-priority message which is not authenticated. If the first user rejects the second user's request to be added to the contact list, the first user's contact options are removed from the contact list of the second user. In another embodiment of the present invention, the first user may unilaterally remove himself or herself from the contact list for the second user.

Turning now to FIG. 5, an exemplary flowchart of operations for transmitting updated information about contact options to other users is shown. The operations listed include those performed by a communication device which transmits data, a user of that communication device and one or more communication devices which receive data. The communication devices have the properties discussed above in regards to FIGS. 1 and 2. The flowchart is generally arranged in temporal sequence, rather than according to which user or communication device is performing each operation.

Broadly speaking, the present invention synchronizes contact options via a “push” mechanism as opposed to a “pull” mechanism. Specifically, contact options for communicating with a user are transmitted (pushed) from that user to other users. However, this fact does not preclude the implementation of functionality wherein a user may request updated contact options for communicating with another user. Such functionality may be useful in the event of data corruption or data loss.

At modifying operation 502, a user modifies at least one of the contact options for communicating with him or her. Modifying operation 502 may include updating contact options which are already stored at the contact list for the user. Such modifications may change any data within the contact option, including without limitation the selection criteria and the addressing information. Modifying operation 502 may also include adding contact options to the contact list for the user. Modifying operation 502 may also include removing contact options from the contact list for the user.

The user may update the selection criteria to cause contact options to be selected which are appropriate given the user's current situation and context. In particular, the user may change the priorities included in the selection criteria to cause specific contact options to be preferred. For example, upon arriving at work, the user may change the selection criteria for a work phone to have a priority of 1. This may cause the priorities of the user's other contact options to be renumbered as unique integers beginning with 2.

The user may change the priorities included in the selection criteria on a frequent basis. The user may even change the priorities multiple times per day as the user moves between different roles throughout the course of a day. Such roles may include, for example, work, home, personal life, commuting and sleeping. Thus, the contact options for communicating with the user may be updated in a manner which is very dynamic.

After modifying operation 502 is completed, control passes to broadcasting operation 504.

At broadcasting operation 504, the modified contact options for communicating with the user are broadcast to a plurality of recipient users. In an embodiment of the present invention, the recipient users include all users included in the contact list. In another embodiment of the present invention, a list of recipient users is maintained separately from the contact list.

Specifically, the contact options modified at modifying operation 502 may be transmitted from the communication device for the broadcasting user (e.g., the user who performed modifying operation 502) to the communication device for each recipient user. This may comprise repeating, for each recipient user, the steps described in transmitting operation 302 of FIG. 3.

Broadcasting operation 504 may be invoked by a variety of user interface devices known in the art. In an embodiment of the present invention, broadcasting operation 504 is invoked when the first user presses a button after completing modifying operation 502. The button may be labeled “Complete”. In another embodiment of the present invention, broadcasting operation 504 may be invoked by a cron job which executes in the background. Those skilled in the art will appreciate that a cron job is a task scheduled to execute at a specific time or time interval in the future. The cron job may execute, for example, once every ten minutes.

At receiving operation 506, the communication device for a recipient user receives the contact options modified at modifying operation 502 from the communication device which performed broadcasting operation 504. Receiving operation 506 may include the steps described in receiving operation 304 and storing operation 306 of FIG. 3. It is emphasized that receiving operation 506 is performed separately by each communication device to which the modified contact options were transmitted.

It is emphasized that after all recipient users have performed receiving operation 506, all recipient users have the most current contact options for the broadcasting user.

It is contemplated that if a first user broadcasts contact options to a second user as shown in FIG. 5, the contact options stored at the contact list for the second user are always synchronized with the contact options stored at the contact list for the first user. Specifically, the second user may not be provided an opportunity to reject received changes to contact options. Furthermore, the second user may be blocked from manually editing contact options which are synchronized according to the method of FIG. 5. However, these restrictions only apply after the second user has been added at the communication device of the first user as shown in FIG. 4. Before that time, a dialog box may provide a user the opportunity to accept or reject incoming changes.

By default, a user may not be notified of incoming changes to contact options. Rather, only two types of events cause notifications to be displayed to a user. The first type is the event wherein another user requests to be added as a contact by the user. The second type is the event wherein the user is deleted as a contact by another user. In an embodiment of the present invention, the notification displayed in response to the second type may be a dialog box. The dialog box may contain a message with text such as, “<UserName> has deleted themselves from your contact list.” In this text, “<UserName>” is replaced by a unique identifier for the user who deleted themselves.

However, some users may want more granularity than provided by the defaults described above. Therefore, in an embodiment of the present invention, a configuration setting is provided by which a user may specify that notifications should be displayed in response to all updates to the contact options. In a further embodiment of the present invention, configuration settings are provided to allow a user to specify which types of notifications should be displayed.

After receiving operation 506 is completed, transmitting updated information about the contact options to other users is complete. However, it is emphasized that the sequence of operations shown in FIG. 5 may be repeated on a regular basis.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

1. A method for managing a plurality of contact options, the method comprising:
receiving at a first communication device having a first user the plurality of contact options from a second communication device having a second user, each of the plurality of contact options comprising a specification of a communications modality, addressing information and selection criteria for communicating with the second user;
automatically selecting, at the first communication device, one of the plurality of contact options based on the selection criteria; and
initiating, at the first communication device, a communication session with the second user according to the communications modality and the addressing information specified in the selected contact option.

2. The method of claim 1, wherein:
the selection criteria comprise a priority; and
selecting one of the plurality of contact options includes selecting, from a set including each of the plurality of contact options not excluded based on the selection criteria, a contact option having a priority which indicates an importance at least as great as is indicated by any other priority included within the set when the set includes two or more contact options.

3. The method of claim 1, further comprising:
transmitting from the second communication device to the first communication device the plurality of contact options for communicating with the second user; wherein first selection criteria include at least one group associated with a first contact option included in the plurality of contact options, each of the at least one groups comprising one or more users; and
omitting the first contact option when transmitting the plurality of contact options from the second communication device to the first communication device if the first user is not included in any of the at least one groups included in the first selection criteria.

4. The method of claim 1, wherein:
at least one of the selection criteria comprise at least one time range for communicating with the second user using the contact option associated with the selection criteria; and
automatically selecting, at the first communication device, one of the plurality of contact options comprises excluding any contact option for which none of the at least one time ranges for communicating with the second user are satisfied.

5. The method of claim 4, wherein the at least one time range comprises at least one day of a week.

6. The method of claim 1, further comprising:
transmitting a request from the first communication device to add the second user at the first communication device; and
receiving an approval from the second user to add the second user at the first communication device.

7. The method of claim 1, further comprising receiving at the first communication device a plurality of updated contact options from the second communication device in response to a modification to at least one of the plurality of contact options.

8. The method of claim 1, further comprising storing the received plurality of contact options at a contact list.

10. A system for managing a plurality of contact options, the system comprising:
a first communication device having a first user, the first communication device configured to:
receive the plurality of contact options from a second communication device having a second user, each of the plurality of contact options comprising a specification of a communications modality, addressing information and selection criteria for communicating with the second user;
automatically select one of the plurality of contact options based on the selection criteria; and
initiate a communication session with the second user according to the communications modality and the addressing information specified in the selected contact option; and
the second communication device having the second user.

11. The system of claim 10, wherein:
the selection criteria comprise a priority; and
selecting one of the plurality of contact options includes selecting, from a set including each of the plurality of contact options not excluded based on the selection criteria, a contact option having a priority which indicates an importance at least as great as is indicated by any other priority included within the set when the set includes two or more contact options.

12. The system of claim 10, wherein:
the second communication device is configured to transmit to the first communication device the plurality of contact options for communicating with the second user;
a first selection criteria includes at least one group associated with a first contact option included in the plurality of contact options, each of the at least one groups comprising one or more users; and
the second communication device is configured to omit the first contact option when transmitting the plurality of contact options to the first communication device if the first user is not included in any of the at least one groups included in the first selection criteria.

13. The system of claim 10, wherein:
at least one of the selection criteria comprise at least one time range for communicating with the second user using the contact option associated with the selection criteria; and
the first communication device is configured to exclude from selection any contact option for which none of the at least one time ranges for communicating with the second user are satisfied.

14. The system of claim 13, wherein the at least one time range comprises at least one day of the week.

15. The system of claim 10, wherein the first communication device is further configured to:
transmit a request to add the second user at the first communication device; and
receive an approval from the second user to add the second user at the first communication device.

16. The system of claim 10, wherein the first communication device is further configured to receive the plurality of updated contact options from the second communication device in response to a modification to at least one of the plurality of contact options.

17. The system of claim 10, wherein the first communication device is further configured to store the received plurality of contact options at a contact list.

18. A computer program product embodied in computer readable memory comprising:
computer readable program codes coupled to the computer readable memory for managing a plurality of contact options, the computer readable program codes configured to cause the program to:
receive at a first communication device having a first user the plurality of contact options from a second communication device having a second user, each of the plurality of contact options comprising a specification of a communications modality, addressing information and selection criteria for communicating with the second user;
automatically select, at the first communication device, one of the plurality of contact options based on the selection criteria; and
initiate, at the first communication device, a communication session with the second user according to the communications modality and the addressing information specified in the selected contact option.

19. The computer program product of claim 18, wherein:
the selection criteria comprise a priority; and
selecting one of the plurality of contact options includes selecting, from a set including each of the plurality of contact options not excluded based on the selection criteria, a contact option having a priority which indicates an importance at least as great as is indicated by any other priority included within the set when the set includes two or more contact options.

20. The computer program product of claim 18, wherein:
the computer readable program codes are further configured to cause the program to transmit from the second communication device to the first communication device the plurality of contact options for communicating with the second user; wherein first selection criteria include at least one group associated with a first contact option included in the plurality of contact options, each of the at least one groups comprising one or more users; and
the computer readable program codes are further configured to cause the program to omit the first contact option when transmitting the plurality of contact options from the second communication device to the first communication device if the first user is not included in any of the at least one groups included in the first selection criteria.
